(19) United States
(12) Patent Application Publication
(10) Pub. No.: US 2024/0411676 A1
(43) Pub. Date: Dec. 12, 2024

(54) Automated software application analysis

(71) Applicant: Virtusa Corporation, Southborough, MA (US)

(72) Inventors: Timothy Beachus, Hingham, MA (US); Dhammike Weerabaddana, Columbo (LK); Abhilash K. Valappil, Hyderabad (IN); Thomas Gardam, Holbrook, MA (US)

(21) Appl. No.: 18/737,971

(22) Filed: Jun. 8, 2024

Related U.S. Application Data
(60) Provisional application No. 63/471,964, filed on Jun. 8, 2023.

(51) Int. Cl. G06F 11/36

(52) U.S. Cl. CPC G06F 11/3692

(57) ABSTRACT

Systems and methods to forensically inspect an existing set of rules built as a Pega application and output detailed metadata on the application's quality, technical debt, cloud readiness and upgradability. That metadata can be used to provide a detailed report on how to remediate and improve the application. In addition, a technical burndown analysis can be completed to show duration, cost savings and productivity details that can be achieved.

### CROSS REFERENCE TO RELATED APPLICATIONS

The present application claims the benefit of and priority to co-pending U.S. provisional application No. 63/471,964, filed on Jun. 8, 2023, the entire content of which is hereby incorporated by reference as if set forth in its entirety herein.

### TECHNICAL FIELD

Embodiments described herein generally relate to systems and methods for analyzing software applications and, more specifically but not exclusively, to systems and methods for generating reports estimating the cost of and identifying issues associated with the remediating of a software application.

### BACKGROUND

Pega Platform applications are built from collections of rules. Each rule specifies a behavior, and different types of rules can control different kinds of application behavior. Pega rules can be used to define workflows, user interfaces, and the display of forms, among other behaviors.

While it may be desirable to remediate a Pega application to utilize new technologies that may not have been available at the time the application was developed (e.g., cloud hosting, generative AI), the scope of the effort required to complete the remediation may be unclear and thereby discourage remediation efforts.

Accordingly, there is a need for methods and systems that can identify the issues associated with remediation and estimate the effort associated with remediation efforts.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method of analyzing a software application. The method includes receiving source code for an application; processing, using a processor, the source code to generate metadata related to at least one technical characteristic of the application; identifying, using the processor, a plurality of issues associated with the application based on the metadata; categorizing, using the processor, each of the plurality of issues into a category; generating, using the processor, a report providing an assessment of the technical state of the software application based on the categorized issues; and presenting, via a user interface, the generated report.

In some embodiments the category is code complexity, duplication, security vulnerabilities, code quality, or test coverage.

In some embodiments the method further includes determining, using the processor, based on remediation effort metrics, at least one of duration, total cost of ownership, and productivity improvement from remediating the application; and presenting information regarding remediating the application in the report.

In some embodiments processing the source code includes executing rules to generate metadata relating to the issues for identification based on predefined rules.

In some embodiments the remediation effort metrics include at least one of developer productivity, developer cost, or number of developers assigned to remediation.

In some embodiments the report identifies a specific code element associated with at least one identified issue. In some embodiments the specific code element is a process, a rule, or a data instance.

According to another aspect, embodiments of the present invention relate to a non-transitory computer-readable medium storing instructions. Those instructions, when executed by a processor, cause the processor to receive source code for an application; process the source code to generate metadata related to at least one technical characteristic of the application; identify a plurality of issues associated with the application based on the metadata; categorize each of the plurality of issues into a category; generate a report providing an assessment of the technical state of the software application based on the categorized issues; and present the generated report.

In some embodiments the category is code complexity, duplication, security vulnerabilities, code quality, or test coverage.

In some embodiments the non-transitory computer-readable medium further includes instructions for determining, based on remediation effort metrics, at least one of duration, total cost of ownership, and productivity improvement from remediating the application; and presenting information regarding remediating the application in the report.

In some embodiments processing the source code includes executing rules to generate metadata relating to the issues for identification based on predefined rules.

In some embodiments the remediation effort metrics include at least one of developer productivity, developer cost, or number of developers assigned to remediation.

In some embodiments the report identifies a specific code element associated with at least one identified issue. In some embodiments the specific code element is a process, a rule, or a data instance.

According to still another aspect, embodiments of the present invention relate to a system for analyzing a software application. The system includes a processor; a user interface; a memory storing instructions that, when executed by the processor, cause the processor to receive source code for an application; provide a metadata generator subsystem configured to process the source code to generate metadata related to at least one technical characteristic of the application; provide an issue identifier subsystem configured to identify a plurality of issues associated with the application based on the metadata; provide a categorizer subsystem configured to categorize each of the plurality of issues into a category; provide a report generator subsystem configured to generate a report providing an assessment of the technical state of the software application based on the categorized issues; and present, via the user interface, the generated report.

In some embodiments the category is code complexity, duplication, security vulnerabilities, code quality, or test coverage.

In some embodiments the memory further includes instructions for determining, based on remediation effort metrics, at least one of duration, total cost of ownership, and productivity improvement from remediating the application; and presenting information regarding remediating the application in the report.

In some embodiments processing the source code includes executing rules to generate metadata relating to the issues for identification based on predefined rules.

In some embodiments the remediation effort metrics include at least one of developer productivity, developer cost, or number of developers assigned to remediation.

In some embodiments the report identifies a specific code element associated with at least one identified issue. In some embodiments the specific code element is a process, a rule, or a data instance.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 is a flowchart of a method for assessing the remediation of a Pega application in accord with the disclosure herein;

FIG. 2 is a flowchart of an exemplary method for identifying technical issues associated with the remediation of a Pega application in accord with the disclosure herein;

FIG. 3 presents an example of a report providing a technical assessment of the issues associated with remediating a Pega application;

FIG. 4 presents another exemplary report organizing the identified technical issues by category and presenting the result as a pie chart;

FIG. 5 presents an exemplary user interface permitting an operator to enter productivity metrics in connection with a savings forecast;

FIG. 6 is an example of a technical debt reduction and savings forecast plan generated in accord with the disclosure herein; and

FIG. 7 is a block diagram of a system for assessing the remediation of a Pega application in accord with the present disclosure.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including standard hard drives, solid state storage, floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Reference will now be made in detail to the exemplary embodiments, examples of which are illustrated in the accompanying drawings. Wherever possible, the same reference numbers will be used throughout the drawings to refer to the same or like parts.

Embodiments of the present invention provide a software implementation of a method (“the RECON tool”) to forensically inspect an existing set of rules built as a Pega application and output detailed metadata on the application's quality, technical debt, cloud readiness and upgradeability.

The metadata can be uploaded to a cloud service where it is analyzed by a cloud-based tool and may be used to provide one or more detailed reports describing how to remediate and improve the application. In addition, a technical burndown analysis can be generated to show duration, cost savings and productivity details that can be achieved.

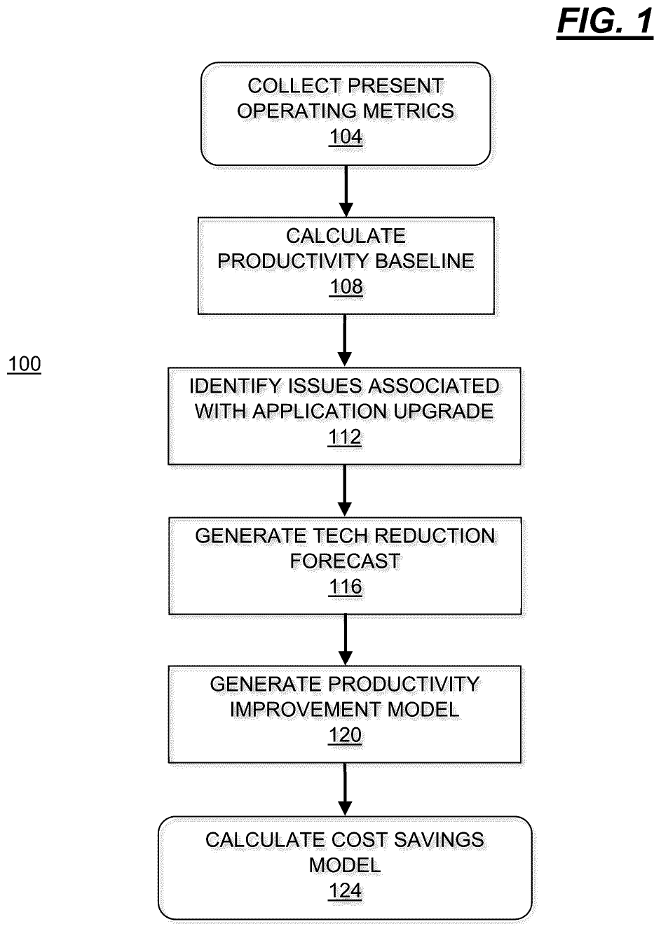

FIG. 1 is a flowchart of a method 100 for assessing the remediation of a Pega application in accord with the disclosure herein. The process begins by collecting current operating metrics for the development environment (Step 104), such as the number of developers employed, the current blended rate of staff costs, and the volume and frequency of production updates. This information can be collected manually, e.g., by interviewing individuals with the relevant information, or automatically, e.g., by interfacing with human resources management systems and databases.

Productivity baseline numbers are computed from the current operating metrics (Step 108). Exemplary baseline numbers include the development team's velocity and the number of production updates over time per developer.

One of more software applications are scanned by an automated software tool, which identifies issues associated with remediating the software applications (Step 112). In some embodiments, the automated software tool may itself be implemented as a Pega Platform application packaged as a ruleset (a set of rules packaged as an importable instance of an application). These issues fall within a variety of categories, including but not limited to quality, technical debt, cloud readiness and upgradeability.

The scanning step may allow an operator to specify an application scan depth and calibrate the app health and cost reduction vectors for each reporting category. The operator may interact with the tool to select which Pega applications are inspected, and also to control the metadata that is generated by the tool.

A tech-debt reduction forecast may be generated from the current operating metrics, the productivity baseline numbers, and/or the technical issues identified with remediating the application (Step 116). In one embodiment the forecast is a quarterly tech-debt reduction team capacity plan. In one embodiment the tech-debt reduction may be forecasted across each application health indicator. The scanning step may be run periodically to validate the forecast.

A developer productivity improvement model may be generated from the tech-debt reduction forecast (Step 120), which may forecast improvements in developer velocity as tech debt is reduced and track improvements in the quantity and quality of production updates. A cost savings model may also be developed based on the forecasted improvements in developer productivity (Step 124).

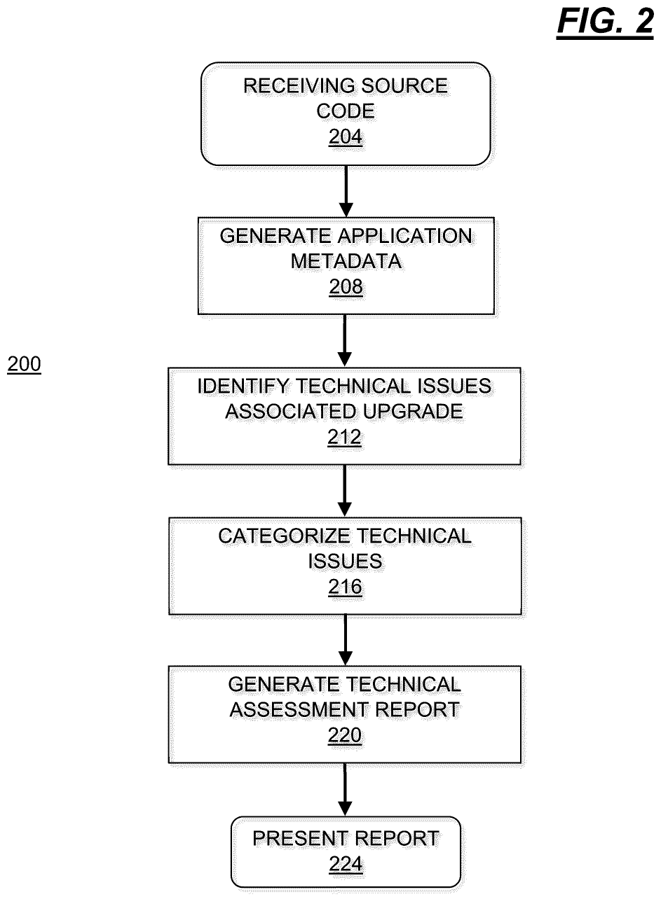

FIG. 2 is a flowchart depicting a process 200 for identifying issues associated with the remediating the software applications. The process may be employed as Step 112 in connection with FIG. 1. The process begins with a configured processor receiving source code for a Pega application (Step 204). In some embodiments the source code is stored in transient memory, such as RAM, while in other embodiments the source code may be stored in a persistent memory, such as a solid state drive.

The configured processor processes the source code to yield a variety of metadata associated with technical characteristics of the application (Step 208). This metadata can be used to identify one or more technical issues associated with the application that can potentially affect the remediating of the application (Step 212). These technical issues can fall into a variety of categories, and categorizing the individual issues can make it easier to make decisions regarding the application remediation process (Step 216). The categorized issues can be presented in a generated report summarizes the technical state of the software application (Step 220), which can be displayed to a user via a user interface (Step 224).

The metadata generated by the tool is uploaded to a cloud service where it is analyzed by a cloud-based tool (“RECON analyze”). The outcome of the processing of the metadata by RECON analyze provides a visual “heatmap” of categorization of the application into green, amber or red flags indicating an assessed health in categories such as quality, technical debt, cloud readiness and upgradeability.

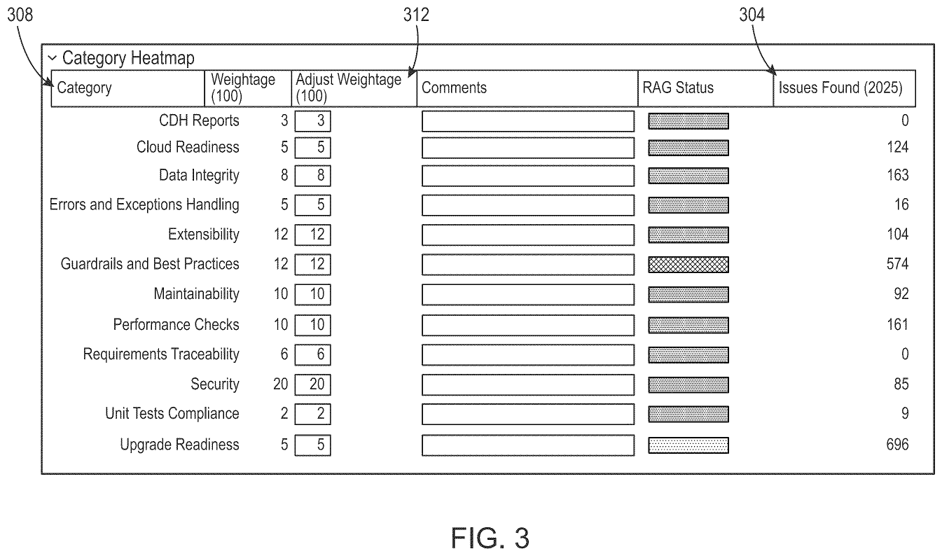

FIG. 3 presents an example of such a heatmap report summarizing the technical state of the software application and identifying issues that may be associated with remediating the application. In the example, a total of 2,025 issues have been identified 304. In some embodiments, this is the result of executing a Pega application containing a rule set against an application under consideration for remediation, with each rule being associated with at least one technical issue.

As can be seen from the example, the issues are organized into a dozen categories 308 to facilitate review and analysis by an operator. These exemplary categories include, but are not limited to: CDH reports, cloud readiness, data integrity, errors and exceptions handling, extensibility, guardrails and best practices, maintainability, performance checks, requirements traceability, security, unit tests compliance, and upgrade readiness.

In some embodiments, the report allows an operator to specify a weight 312 associated with each category, permitting particular categories of issues to be emphasized or deemphasized in comparison to other categories of issues. This prioritization is used below when completing the technical debt analysis and reduction forecast.

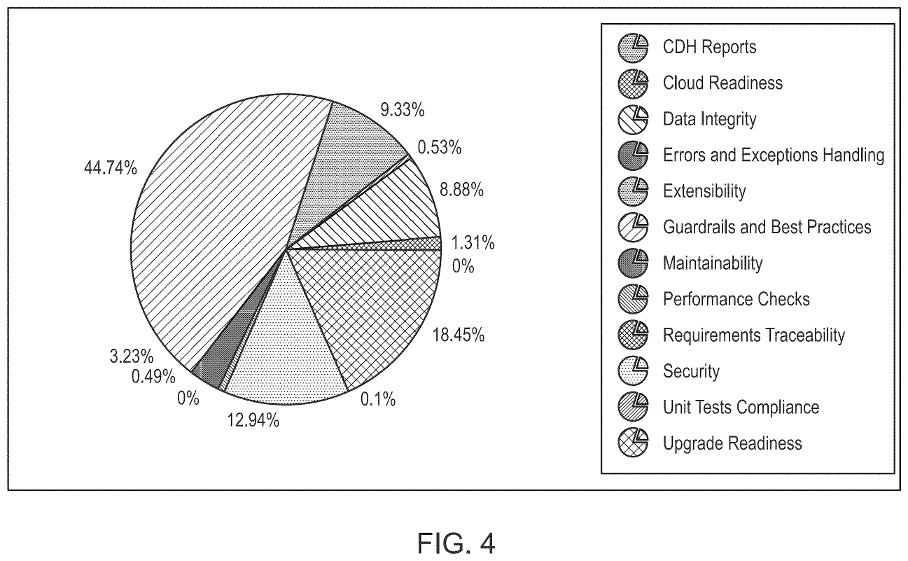

The data provided by the RECON analyze tool may be presented in a variety of different formats. FIG. 4 presents an example of a report organizing the identified technical issues by category. These exemplary categories include, but are not limited to: CDH reports, cloud readiness, data integrity, errors and exceptions handling, extensibility, guardrails and best practices, maintainability, performance checks, requirements traceability, security, unit tests compliance, and upgrade readiness. The piechart indicates the relative percentage of each category of issues although other embodiments may present the raw number of issues in addition to or instead of the percentage.

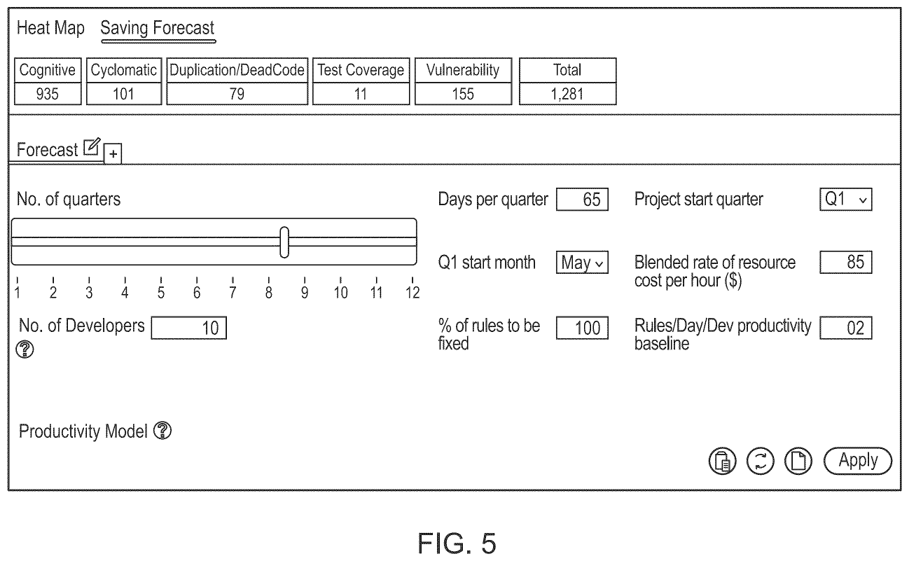

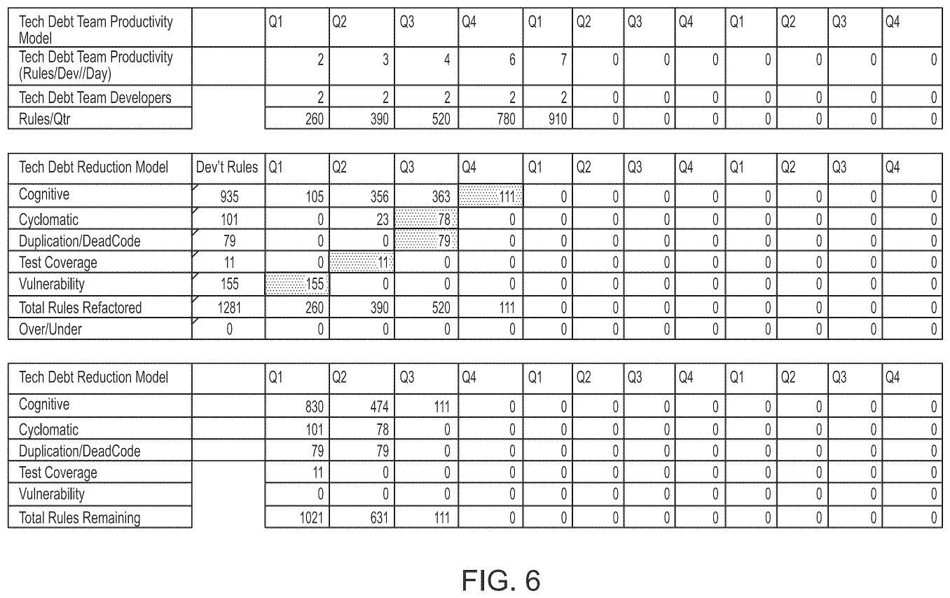

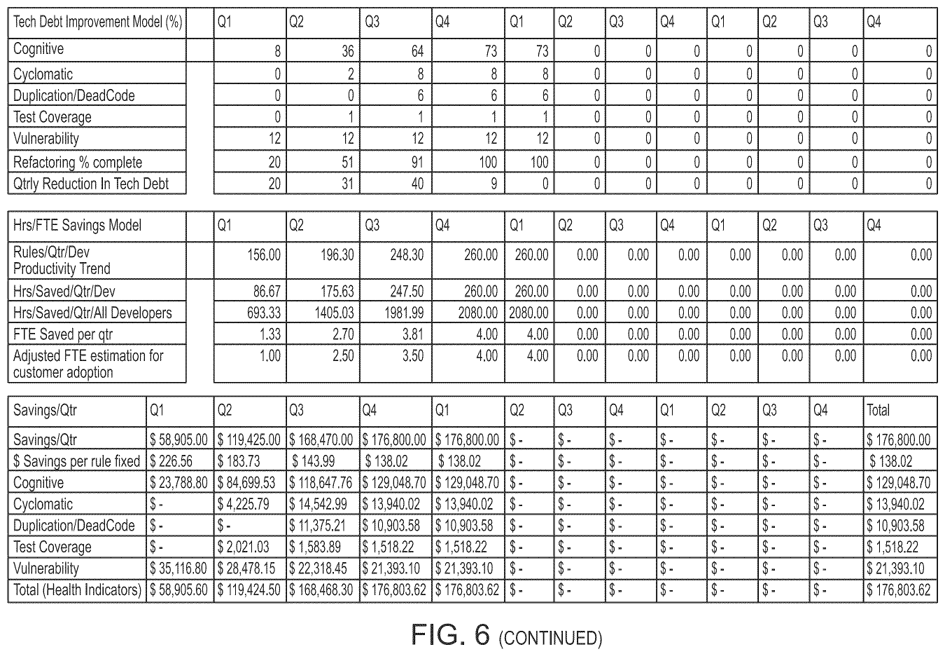

In addition to the reports, a master file of data is produced that indicates issues with the analyzed PEGA application that need attention in different issue categories (i.e., security, best practice, upgradeability, performance, etc.). As illustrated in FIG. 5, these issue categorizations are used to roll up to five key areas of impact in cognitive, cyclomatic, complexity, duplication/dead end, test coverage and vulnerability (security). The user interface of FIG. 5 permits an operator to specify adding additional metrics of current developer productivity, blended cost of developer headcount, allocation of developers to remediate tech debt, at which point RECON analyze is able to determine the duration, cost, productivity improvement, and overall savings in a model that, as shown in FIG. 6, can be presented to the customer.

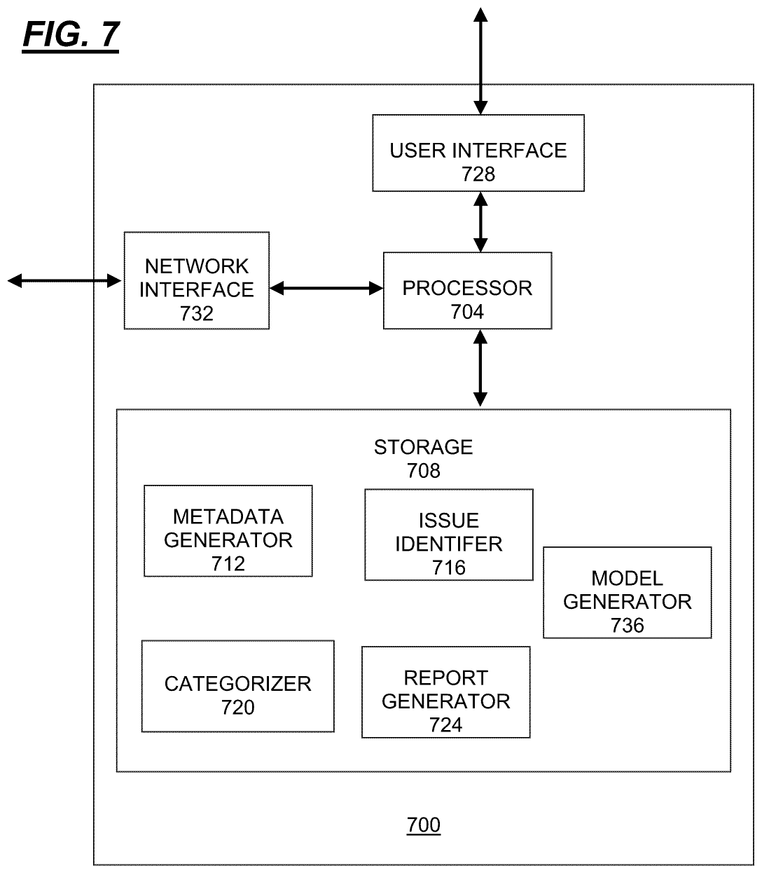

FIG. 7 depicts an example of a Pega application analysis system 700 in accord with this disclosure. The analysis system 700 includes a processor 704. The analysis system 700 also includes a storage 708 coupled to the processor 704. The storage 708 comprises a set of program instructions in the form of a plurality of subsystems, configured to be executed by the processor 704.

The processor(s) 704, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The storage 708 includes a plurality of subsystems stored in the form of executable programs which instructs the processor 704 to perform the method steps. The plurality of subsystems includes: a metadata generator subsystem 712, an issue identifier subsystem 716, a categorizer subsystem 720 and a report generator subsystem 724.

Computer memory elements implementing the storage 708 may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) 704.

Although FIG. 7 illustrates the analysis system 700 including a user interface 728, one skilled in the art can envision that the analysis system 700 can be connected to several user devices (not shown) located at different locations via the network interface 732. In one embodiment, a web application may be hosted on a remote web server and loaded on a “web browser” on a user device. In such case, the analysis system 700 may be a remote web server.

The plurality of subsystems includes a metadata generator subsystem 712. The metadata generator subsystem 712 is configured to apply a plurality of Pega rules to a Pega application, which itself may be implemented as a plurality of Pega rules. Each Pega rule applied to the application may be developed to address a particular issue relevant to the maintainability and/or upgradability of the application. The result of each rule is metadata concerning the application, which may be compiled and aggregated as part of the analysis process. In one exemplary embodiment, the analysis system 700 may receive the Pega application and/or the Pega rules via the user interface 728 and/or the network interface 732.

The plurality of subsystems also includes an issue identifier subsystem 716. The issue identifier subsystem 716 is configured to process the generated metadata and identify the issues associated with remediation of the application described by the metadata.

The plurality of subsystems also includes a categorizer subsystem 720. The categorizer subsystem 720 is configured to take the issues from the issue identifier subsystem 716 and categorize them into a variety of categories, making it easier to make decisions regarding application remediation. Exemplary categories used in various embodiments include CDH reports, cloud readiness, data integrity, errors and exceptions handling, extensibility, guardrails and best practices, maintainability, performance checks, requirements traceability, security, unit tests compliance, and upgrade readiness.

The plurality of subsystems also includes a report generator subsystem 724. The report generator 724 is configured to take the issues from the issue identifier subsystem 716, either prior to or after categorization by the categorizer subsystem 720, and present it in a variety of formats, such as a heatmap or pie chart.

The plurality of subsystems also includes a model generator subsystem 736. The model generator subsystem 736 permits an operator to enter operating metrics for analysis, such as the number of developers employed, the current blended rate of staff costs, and the volume and frequency of production updates. In some embodiments the model generator subsystem 736 collects this data from interacting with other computer systems. The model generator subsystem 736 may compute productivity numbers from the operating metrics.

The model generator subsystem 736 may generate a tech-debt reduction forecast from the operating metrics, the productivity numbers and/or the technical issues identified with remediating the application. Exemplary reduction forecasts include a quarterly tech-debt reduction team capacity plan.

The model generator subsystem 736 may also generate a developer productivity improvement model from the tech-debt reduction forecast which may forecast improvements in developer velocity as tech debt is reduced.

The model generator subsystem 736 may also generate a cost savings model based on the forecasted improvements in developer productivity.

The software and analysis tooling provides a deeper and broader depth of observation than competing alternates. The analysis can be completed in a matter of days versus months using alternatives. The ability to categorize the technical debt, deprecation, and implementation into a prioritized list of actions focused on cognitive, cyclomatic, complexity, duplication/dead code, test coverage and vulnerability (security) aspects gives a considerable additive level of detail and comprehensiveness of observations.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. The systems and methods involving hardware and software and/or functional parts therefore may be physically integrated into or housed inside or attached to another device, be it an imaging device, a stimulus or electrophysiological recording device, and patient audio device, etc. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method of analyzing a software application, the method comprising:
receiving source code for an application;
processing, using a processor, the source code to generate metadata related to at least one technical characteristic of the application;
identifying, using the processor, a plurality of issues associated with the application based on the metadata;
categorizing, using the processor, each of the plurality of issues into a category;
generating, using the processor, a report providing an assessment of the technical state of the software application based on the categorized issues; and
presenting, via a user interface, the generated report.

2. The method of claim 1, wherein the category is code complexity, duplication, security vulnerabilities, code quality, or test coverage.

3. The method of claim 1, further comprising:
determining, using the processor, based on remediation effort metrics, at least one of duration, total cost of ownership, and productivity improvement from remediating the application; and
presenting information regarding remediating the application in the report.

4. The method of claim 1, wherein processing the source code comprises executing rules to generate metadata relating to the issues for identification based on predefined rules.

5. The method of claim 1, wherein the remediation effort metrics comprise at least one of developer productivity, developer cost, or number of developers assigned to remediation.

6. The method of claim 1, wherein the report identifies a specific code element associated with at least one identified issue.

7. The method of claim 6, wherein the specific code element is a process, a rule, or a data instance.

8. A non-transitory computer-readable medium storing instructions that, when executed by a processor, cause a processor to:
receive source code for an application;
process the source code to generate metadata related to at least one technical characteristic of the application;
identify a plurality of issues associated with the application based on the metadata;
categorize each of the plurality of issues into a category;
generate a report providing an assessment of the technical state of the software application based on the categorized issues; and
present the generated report.

9. The non-transitory computer-readable medium of claim 8, wherein the category is code complexity, duplication, security vulnerabilities, code quality, or test coverage.

10. The non-transitory computer-readable medium of claim 8 further comprising instructions for:
determining, based on remediation effort metrics, at least one of duration, total cost of ownership, and productivity improvement from remediating the application; and
presenting information regarding remediating the application in the report.

11. The non-transitory computer-readable medium of claim 8, wherein processing the source code comprises executing rules to generate metadata relating to the issues for identification based on predefined rules.

12. The non-transitory computer-readable medium of claim 8, wherein the remediation effort metrics comprise at least one of developer productivity, developer cost, or number of developers assigned to remediation.

13. The non-transitory computer-readable medium of claim 8, wherein the report identifies a specific code element associated with at least one identified issue.

14. The non-transitory computer-readable medium of claim 13, wherein the specific code element is a process, a rule, or a data instance.

15. A system for analyzing a software application, the system comprising:
a processor;
a user interface;
a memory storing instructions that, when executed by the processor, cause the processor to:
receive source code for an application;
provide a metadata generator subsystem configured to process the source code to generate metadata related to at least one technical characteristic of the application;
provide an issue identifier subsystem configured to identify a plurality of issues associated with the application based on the metadata;
provide a categorizer subsystem configured to categorize each of the plurality of issues into a category;
provide a report generator subsystem configured to generate a report providing an assessment of the technical state of the software application based on the categorized issues; and
present, via the user interface, the generated report.

16. The system of claim 15, wherein the category is code complexity, duplication, security vulnerabilities, code quality, or test coverage.

17. The system of claim 15, wherein the memory further comprises instructions for:
determining, based on remediation effort metrics, at least one of duration, total cost of ownership, and productivity improvement from remediating the application; and
presenting information regarding remediating the application in the report.

18. The system of claim 15, wherein processing the source code comprises executing rules to generate metadata relating to the issues for identification based on predefined rules.

19. The system of claim 15, wherein the remediation effort metrics comprise at least one of developer productivity, developer cost, or number of developers assigned to remediation.

20. The system of claim 15, wherein the report identifies a specific code element associated with at least one identified issue.

21. The system of claim 20, wherein the specific code element is a process, a rule, or a data instance.
